(19) United States
(12) Patent Application Publication
(10) Pub. No.: US 2012/0319956 A1
(43) Pub. Date: Dec. 20, 2012

(54) EAVESDROPPING RESISTANT TOUCHSCREEN SYSTEM

(75) Inventors: David Paul TALACH, Sacramento, CA (US); Mehran MIRKAZEMI, Rocklin, CA (US); Christopher Hugh DELGADO, Rocklin, CA (US)

(73) Assignee: VERIFONE, INC., San Jose, CA (US)

(21) Appl. No.: 13/162,024

(22) Filed: Jun. 16, 2011

(51) Int. Cl. G06F 3/02; G06F 3/041

(52) U.S. Cl. 345/168; 345/173

(57) ABSTRACT

An eavesdropping-resistant touchscreen system suitable for use by visually impaired users, the system including a visual eavesdropping-resistant security layer for restricting viewability of visually sensible indicia to within a relatively narrow limited field of view and a tactile layer providing a plurality of preferably selectably actuable tactile indicia at least one of which is associated with the visually sensible indicia.

### FIELD OF THE INVENTION

The present invention relates to touchscreens generally and more particularly to touchscreens having keypad functionality.

### BACKGROUND OF THE INVENTION

The following patent publications are believed to represent the current state of the art:

U.S. Pat. Nos. 5,909,315; 6,021,944; 6,239,911; 6,262,843; 6,543,684; 6,552,850; 7,052,746 and 7,247,356;

U.S. Published Patent Application Nos. 2001/0006181; 2005/0002098; 2006/0073891; 2006/0191177; 2007/0253065; 2009/0303022 and 2009/0242142;

European Patent No. EP0802684B1;

European Published Application Nos. EP01647950; EP00969427 and EP00802684;

Published PCT Patent Application Nos. WO2001/067374, WO2006/039572 and WO2007/118122;

Great Britain Patent No. GB02422355;

French Patent Publication No. FR2707407; and

German Patent No. DE10226567.

### SUMMARY OF THE INVENTION

The present invention seeks to provide a touchscreen having secure keypad functionality which is suitable for use by visually impaired persons.

There is thus provided in accordance with a preferred embodiment of the present invention an eavesdropping-resistant touchscreen system suitable for use by visually impaired users, the system including a visual eavesdropping-resistant security layer for restricting viewability of visually sensible indicia to within a relatively narrow limited field of view and a tactile layer providing a plurality of preferably selectably actuable tactile indicia at least one of which is associated with the visually sensible indicia.

Preferably, the eavesdropping-resistant touchscreen system suitable for use by visually impaired users also includes a display layer providing the visible indicia indicating key entry locations on a display. Additionally, the display layer designates key entry locations corresponding to one of a plurality of selectable keypads. In accordance with a preferred embodiment of the present invention the display layer includes movable keyboard position selection functionality for generating a keypad at one of a plurality of selectable locations.

Preferably, the eavesdropping-resistant touchscreen system suitable for use by visually impaired users also includes a user finger location sensing layer for sensing the location of a finger on a particular key of the keypad. Additionally, the user finger location sensing layer is also operative in association with user finger location sensing functionality for actuating at least some of the plurality of tactile indicia when they are shielded from view by a user's fingers. In accordance with a preferred embodiment of the present invention the plurality of tactile indicia are selectably actuable and some, but not others, of the plurality of tactile indicia are actuated at given times.

Preferably, the movable keyboard position selection functionality is operative for generating a keypad at an unpredictably selected one of a plurality of selectable locations. Additionally or alternatively, some but not all of the plurality of tactile indicia are actuated to correspond to the selectable locations at different times.

In accordance with a preferred embodiment of the present invention the plurality of tactile indicia include physical protrusions. Preferably, the plurality of tactile indicia include selectably actuable EAP protrusions.

Preferably, the security layer includes a polarized security screen.

In accordance with a preferred embodiment of the present invention the display layer provides visible indicia indicating key entry locations on a display having a number of potential key entry locations which is greater than the number of key entry locations defining the keyboard.

Preferably, the order of the layers from top to bottom is the security layer which is above the tactile layer, which is above the display layer, which is above the user finger location sensing layer. Alternatively, the order of the layers from top to bottom is the security layer which is above the display layer, which is above the tactile layer, which is above the user finger location sensing layer. In another alternative embodiment the order of the layers from top to bottom is the tactile layer which is above the security layer, which is above the user finger location sensing layer, which is above the display layer.

### BRIEF DESCRIPTION OF THE DRAWINGS

The present invention will be understood and appreciated more fully from the following detailed description, taken in conjunction with the drawings in which:

FIG. 1 is a simplified illustration of the structure and operation of an eavesdropping-resistant touchscreen system suitable for use by visually impaired users in the context of an automatic teller machine, in accordance with a preferred embodiment of the present invention; and

FIGS. 2A & 2B are simplified illustrations of two alternative electrode structures useful in the eavesdropping-resistant touchscreen system of FIG. 1.

### DETAILED DESCRIPTION OF PREFERRED EMBODIMENTS

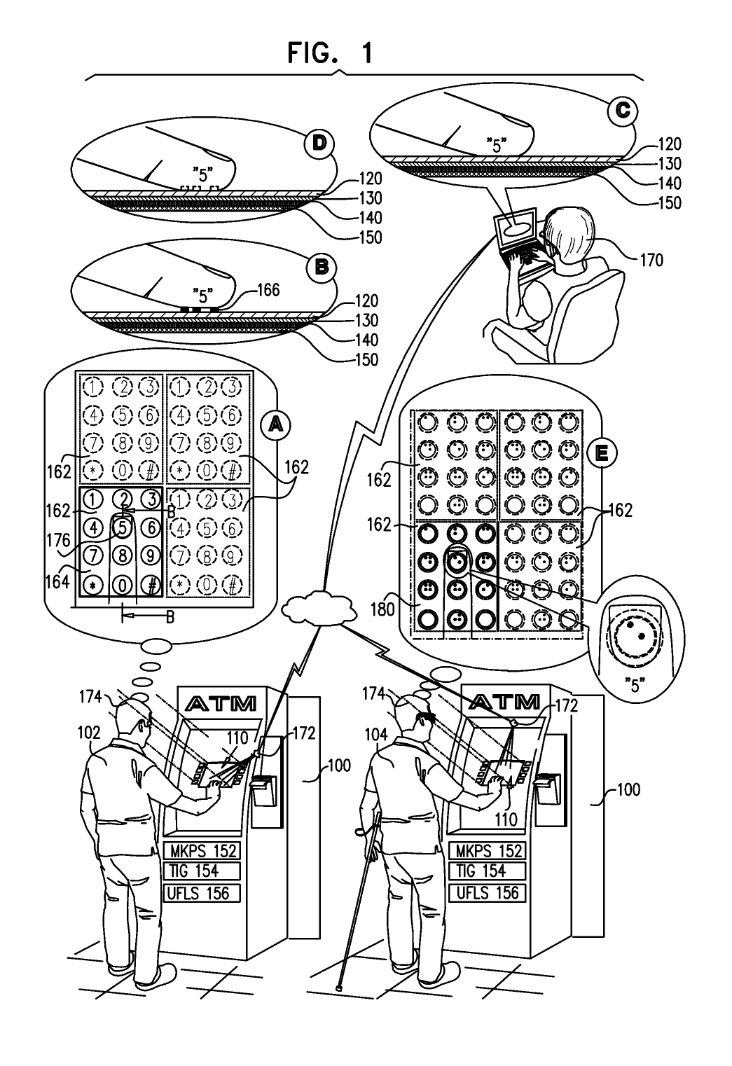

Reference is now made to FIG. 1, which is a simplified illustration of the structure and operation of an eavesdropping-resistant touchscreen system suitable for use by visually impaired users in the context of an automatic teller machine, in accordance with a preferred embodiment of the present invention. It is appreciated that the present invention is not limited to use within the context of automatic teller machines and is suitable for use with any device having keypad functionality for entry of sensitive information. Such devices are particularly useful with point of sale (POS) terminals such as cash registers, credit card acceptors, PIN pads and the like.

FIG. 1 illustrates two instances of use of an automatic teller (ATM) machine 100, one by a sighted person, designated by reference numeral 102, and one by a visually-impaired person, designated by reference numeral 104. In accordance with a preferred embodiment of the present invention, the ATM 100 includes an eavesdropping-resistant touchscreen system constructed and operative in accordance with a preferred embodiment of the invention. It is appreciated that the present invention is equally applicable with other types of devices having keypad functionality for entry of sensitive information, such as, for example, a Model MX-870 commercially available from Verifone, Inc. The present invention is particularly suitable for use by visually impaired persons using POS devices located in retail transaction lanes, wherein over the shoulder eavesdropping could occur.

The eavesdropping-resistant touchscreen system preferably includes an eavesdropping-resistant specific key entry location indicating tactile touchscreen (ERTT) assembly 110.

In accordance with a preferred embodiment of the invention, the ERTT assembly 110 preferable includes four distinct functional layers, designed by reference numerals 120, 130, 140 and 150. The four functional layers preferably include:

a display layer providing visible indicia indicating key entry locations on a display having a number of potential key entry locations which is greater than the number of key entry locations defining the keyboard. The display layer employs movable keyboard position selection (MKPS) functionality 152 for generating a keypad at one of a plurality of selectable locations;

a visual eavedropping-resistant security (VERS) layer, preferably a polarizer screen, such as a screen described in Published PCT Patent Application WO2007/118122 of 3M for restricting viewability of the visually sensible indicia to within a relatively narrow limited field of view;

a tactile layer providing a plurality of preferably selectably actuable tactile indicia corresponding to the visually sensible indicia, associated with tactile indicia generation (TIG) functionality 154;

a user finger location sensing (UFLS) layer for sensing the location of a finger on a particular key of the keypad, associated with UFLS functionality 156.

It is appreciated that the various orders of the four layers as layers 120, 130, 140 and 150 may be employed and, alternatively, that in practice the above four functional layers may be incorporated in a lesser number of physical layers, some of which may have multiple ones of the above listed functions.

Preferably layer 120 is the VERS layer. If all of the UFLS, display and tactile layers are sufficiently transparent, their order may be any suitable order. One preferred order of layers 120, 130, 140 and 150 is as follows:

Layer 120—VERS

Layer 130—tactile

Layer 140—display

Layer 150—UFLS

Another preferred order of layers 120, 130, 140 and 150 is as follows:

Layer 120—VERS

Layer 130—display

Layer 140—tactile

Layer 150—UFLS

A further alternative preferred order of layers 120, 130, 140 and 150 is as follows:

Layer 120—tactile

Layer 130—VERS

Layer 140—UFLS

Layer 150—display

The user finger location sensing (UFLS) layer may employ UFLS functionality such as that provided by a CY8C20666 chip, commercially available from Cypress Semiconductors, Inc., employing conventional capacitive sensing techniques, such as CAPSENSE®.

As shown in FIG. 1, a plurality of selectable key entry locations are indicated by reference numeral 162. Selection of the location of the keyboard the display is preferably effected in a random or near random manner.

The tactile layer preferably employs an electroactive polymer in accordance with the teachings of U.S. Published Patent Application 2010/0109486, the disclosure of which is hereby incorporated by reference.

As seen in FIG. 1, at enlargement A, a sighted user of the ATM views a selected keypad 164 on ERTT assembly 110. Normally, when his finger overlies a particular key of the selected keypad 164, such as the “5” key, as shown, he engages tactile indicia 166, which he may or may not notice. These tactile indicia, shown schematically at enlargement B, are preferably raised portions of a tactile layer.

The user may then press a key, such as the “5” key as shown at enlargement D, producing a data entry, which is sensed by the UFLS layer and associated UFLS functionality.

Due to the presence of the VERS layer, an eavesdropper, designated by reference numeral 170, viewing the ERTT assembly 110 from a surreptitiously hidden camera 172, which is located outside of the field of view 174 permitted by the VERS layer, cannot see the visually sensible indicia 176 produced by the display layer. Due to the location of the user's finger overlying the tactile indicia 166, the eavesdropper 170 only sees the finger of the user and cannot see the raised tactile indicia 166, as shown in enlargement C.

As also shown in FIG. 1, at enlargement E, a visually impaired user 104 of the ATM 100 engages an unpredictably located keypad 180 on ERTT assembly 110. He moves his finger across the ERTT assembly 110 to search for a desired key. When his finger overlies a particular key of the selected keypad 180, such as the “5” key, as shown, without necessarily pressing the key or even engaging the keypad surface, ULSF functionality senses the presence of his finger and causes the tactile layer to generate tactile indicia 166, which indicate to the visually impaired user 104 that his finger overlies the “5”. These tactile indicia, shown schematically at enlargement B, are preferably raised portions of the tactile layer, forming part of the ERTT assembly 110, in accordance with a preferred embodiment of the present invention.

Due to the presence of the VERS layer, an eavesdropper, designated by reference numeral 170, viewing the ERTT assembly 110 from a surreptitiously hidden camera 172, which is located outside of the field of view 174 permitted by the VERS layer, cannot see the visually sensible indicia 176 produced by the display layer. Due to the location of the user's finger overlying the tactile indicia 166, the eavesdropper 170 only sees the finger of the user and cannot see the raised tactile indicia 166, as shown in enlargement C.

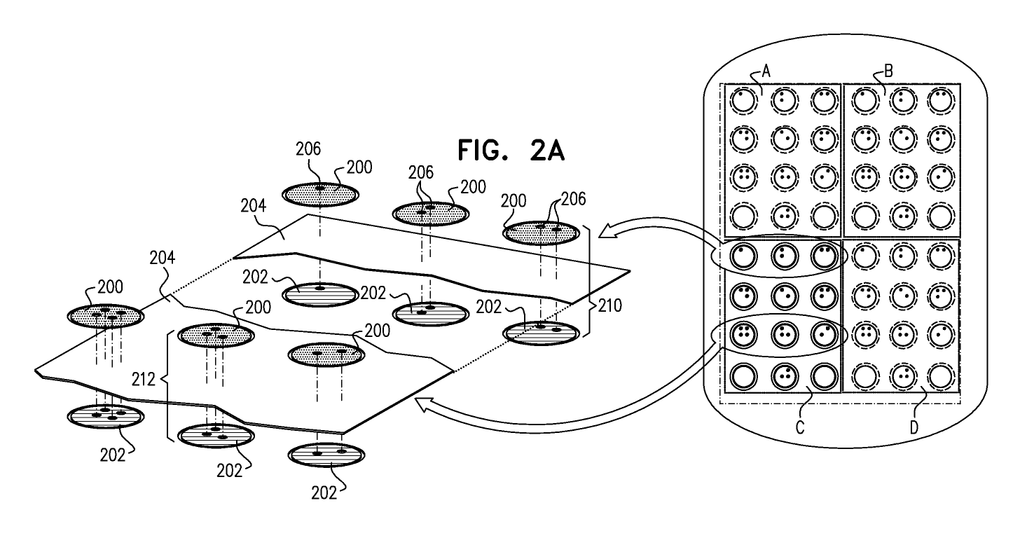

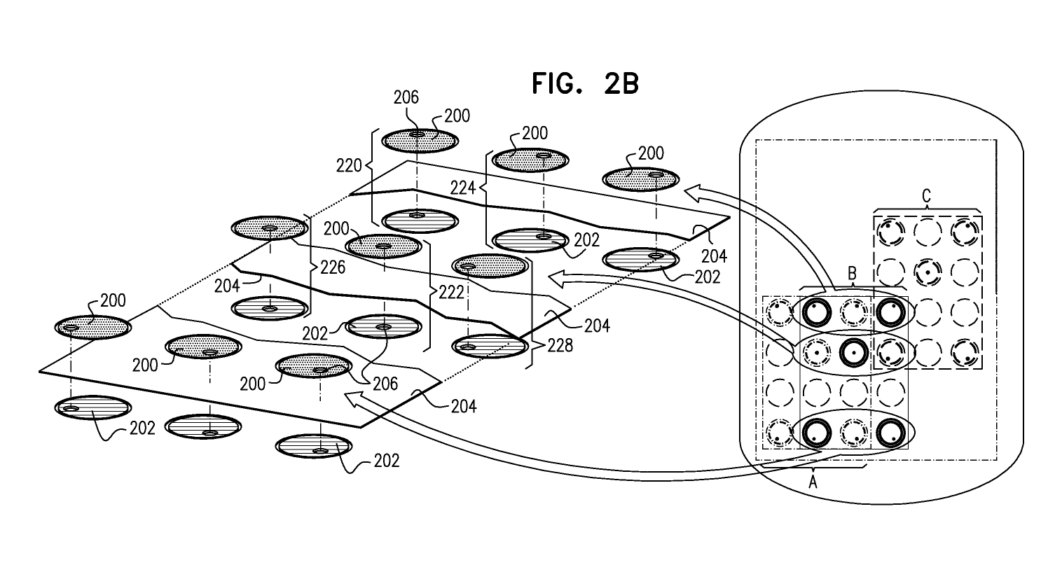

Reference is now made to FIGS. 2A & 2B, which are simplified illustrations of two alternative electrode structures useful in the eavesdropping-resistant touchscreen system of FIG. 1.

Turning to FIG. 2A, there is seen an electrode arrangement for an eavesdropping-resistant touchscreen wherein a tactile input in the form of a Braille pattern is provided at each key entry location. The Braille tactile pattern represents a number associated with each key entry location.

In the embodiment of FIG. 2A, in accordance with the teachings of U.S. Published Patent Application 2010/0109486, identical upper and lower electrodes 200 and 202 are provided at each key entry location and are separated by a layer 204 of an electroactive polymer (EAP). Each pair of identical electrodes 200 and 202 is formed with one or more apertures 206. When a predetermined voltage is applied across the electrodes 200 and 202, the EAP layer bulges through the corresponding aperture or apertures, at least at electrode 200 of each pair, producing a touch sensible protrusion thereat.

It is seen that in the embodiment of FIG. 2A, a 6×8 array of electrodes 200 and 202 provides four selectable side by side keypads, designed by letters A, B, C and D. It is seen for example in keypad C that a pair of electrodes 200 and 202 designated by reference numeral 210 designates the number “3” in Braille notation and that a pair of electrodes 200 and 202 designated by reference numeral 212 designates the number “8” in Braille notation.

Turning to FIG. 2B, there is seen an electrode arrangement for an eavesdropping-resistant touchscreen wherein a tactile input in the form of a corner and “5” key designating pattern is provided. It is seen that in the embodiment of FIG. 2B, there are provided plural partially overlapping keypads, designed by letters A, B and C.

In the embodiment of FIG. 2B, also in accordance with the teachings of U.S. Published Patent Application 2010/0109486, identical upper and lower electrodes 200 and 202 are located at the corners and at the “5” key location of each of three keypads, respectively labeled A, B and C. The electrodes 200 and 202 are separated by a layer 204 of an electroactive polymer (EAP). Each pair of identical electrodes 200 and 202 at the corners of the keypad and at the “5” key is formed with an aperture 206. When a predetermined voltage is applied across the pair of electrodes 200 and 202, the EAP layer bulges through the corresponding aperture, at least at electrode 200 of each pair, producing a touch sensible protrusion thereat.

It is seen, for example, in keypad B that a pair of electrodes 200 and 202 designated by reference numeral 220 designates the upper left hand corner of keypad B and that a pair of electrodes 200 and 202 indicated by reference numeral 222 designates the key representing the number “5” of keypad B. It is further seen, for example, in keypad A that a pair of electrodes 200 and 202 indicated by reference numeral 224 designates the upper right hand corner of keypad A and that a pair of electrodes 200 and 202 indicated by reference numeral 226 designates the key representing the number “5” of keypad A. It is also seen, for example, in keypad C that a pair of electrodes 200 and 202 indicated by reference numeral 228 designates the lower left hand corner of keypad C. It is noted that the key entry locations of keys which are not at the corners or at the “5” key location are indicated by single dashed circles, and no electrodes need be located at these key entry locations.

It is appreciated that a pair of electrodes 200 and 202 with corresponding apertures 206 may be located at all key entry locations. It is also appreciated that the pair of electrodes may include apertures having different shapes, to provide a tactile feedback indicating the key entry location.

It is appreciated that for each use instance, the movable keyboard position selection MKPS functionality 152 acts in a random or pseudorandom manner, to select one of the plural keypads 162 to be used. In one embodiment of the invention, the ERTT assembly 110 actuates all of the visually sensible and tactile indicia appropriate for that keypad. According to an alternative embodiment of the invention, at least the tactile indicia are not all actuated together but rather are actuated only when a user's finger passes over the key entry location as sensed by the UFLS functionality 156 (FIG. 1). An actual key entry is effected by the UFLS functionality 156 only when a user's finger dwells over the key entry location or applies at least a predetermined threshold pressure thereto.

It will be appreciated by persons skilled in the art that the present invention is not limited by what has been particularly shown and described hereinabove. Rather the present invention includes both combinations and subcombinations of various features described hereinabove as well as modifications and variations thereof which would occur to a person skilled in the art upon reading the foregoing and which are not in the prior art.

1. An eavesdropping-resistant touchscreen system suitable for use by visually impaired users, the system comprising:
a visual eavesdropping-resistant security layer for restricting viewability of visually sensible indicia to within a relatively narrow limited field of view; and
a tactile layer providing a plurality of preferably selectably actuable tactile indicia at least one of which is associated with said visually sensible indicia.

2. An eavesdropping-resistant touchscreen system suitable for use by visually impaired users according to claim 1 and also comprising:
a display layer providing said visible indicia indicating key entry locations on a display.

3. An eavesdropping-resistant touchscreen system suitable for use by visually impaired users according to claim 2 and wherein said display layer designates key entry locations corresponding to one of a plurality of selectable keypads.

4. An eavesdropping-resistant touchscreen system suitable for use by visually impaired users according to claim 2 and wherein said display layer comprises movable keyboard position selection functionality for generating a keypad at one of a plurality of selectable locations.

5. An eavesdropping-resistant touchscreen system suitable for use by visually impaired users according to claim 1 and also comprising:
a user finger location sensing layer for sensing the location of a finger on a particular key of the keypad.

6. An eavesdropping-resistant touchscreen system suitable for use by visually impaired users according to claim 5 and wherein said user finger location sensing layer is also operative in association with user finger location sensing functionality for actuating at least some of said plurality of tactile indicia when they are shielded from view by a user's fingers.

7. An eavesdropping-resistant touchscreen system suitable for use by visually impaired users according to claim 5 and wherein said plurality of tactile indicia are selectably actuable and wherein some, but not others, of said plurality of tactile indicia are actuated at given times.

8. An eavesdropping-resistant touchscreen system suitable for use by visually impaired users according to claim 2 and also comprising:
a user finger location sensing layer for sensing the location of a finger on a particular key of the keypad.

9. An eavesdropping-resistant touchscreen system suitable for use by visually impaired users according to claim 8 and wherein said user finger location sensing layer is also operative in association with user finger location sensing functionality for actuating at least some of said plurality of tactile indicia when they are shielded from view by a user's fingers.

10. An eavesdropping-resistant touchscreen system suitable for use by visually impaired users according to claim 4 and wherein said movable keyboard position selection functionality is operative for generating a keypad at an unpredictably selected one of a plurality of selectable locations.

11. An eavesdropping-resistant touchscreen system suitable for use by visually impaired users according to claim 4 and wherein some but not all of said plurality of tactile indicia are actuated to correspond to said selectable locations at different times.

12. An eavesdropping-resistant touchscreen system suitable for use by visually impaired users according to claim 1 wherein said plurality of tactile indicia comprise physical protrusions.

13. An eavesdropping-resistant touchscreen system suitable for use by visually impaired users according to claim 1 wherein said plurality of tactile indicia comprise selectably actuable EAP protrusions.

14. An eavesdropping-resistant touchscreen system suitable for use by visually impaired users according to claim 1 and wherein said security layer comprises a polarized security screen.

15. An eavesdropping-resistant touchscreen system suitable for use by visually impaired users according to claim 2 and wherein said display layer provides visible indicia indicating key entry locations on a display having a number of potential key entry locations which is greater than the number of key entry locations defining the keyboard.

16. An eavesdropping-resistant touchscreen system suitable for use by visually impaired users according to claim 8 and wherein the order of said layers from top to bottom is:
said security layer which is above said tactile layer, which is above said display layer, which is above said user finger location sensing layer.

17. An eavesdropping-resistant touchscreen system suitable for use by visually impaired users according to claim 8 and wherein the order of said layers from top to bottom is:
said security layer which is above said display layer, which is above said tactile layer, which is above said user finger location sensing layer.

18. An eavesdropping-resistant touchscreen system suitable for use by visually impaired users according to claim 8 and wherein the order of said layers from top to bottom is:
said tactile layer which is above said security layer, which is above said user finger location sensing layer, which is above said display layer.
